(19) United States
(12) Patent Application Publication
(10) Pub. No.: US 2020/0257681 A1
(43) Pub. Date: Aug. 13, 2020

(54) SYSTEM FOR STORING AND SEARCHING BIG DATA IN REAL-TIME

(71) Applicant: DATASTREAMS CORP., Seoul (KR)

(72) Inventor: Seung Tae Chun, Gyeonggi-do (KR)

(73) Assignee: DATASTREAMS CORP., Seoul (KR)

(21) Appl. No.: 16/860,732

(22) Filed: Apr. 28, 2020

Related U.S. Application Data
(63) Continuation of application No. PCT/KR2017/012801, filed on Nov. 13, 2017.

(30) Foreign Application Priority Data
Nov. 1, 2017 (KR) 10-2017-0144896

(51) Int. Cl. G06F 16/242; G06F 16/182

(52) U.S. Cl. CPC G06F 16/2433; G06F 16/182

(57) ABSTRACT

The present invention relates to a system for storing and searching big data in real-time, wherein the system stores data in real-time in response to mass data generation without data loss in a memory, and allows the same to simultaneously be searched in real-time; and leaves only a predetermined amount of the data in a memory, stores the remaining old data in a Hadoop distributed file system (HDFS) in a structured format, and allows the same to be swiftly searched.

### CROSS-REFERENCE TO RELATED APPLICATION

This U.S. non-provisional application is a continuation application of PCT International Application PCT/KR2017/012801, which has an International filing date of Nov. 13, 2017, and claims the benefit of priority to Korean Patent Application No. 10-2017-0144896, which has an filing date of Nov. 1, 2017, the entire contents of which are incorporated herein by reference in their entirety.

### BACKGROUND

### 1. Field of the Invention

The present invention relates to a system for storing and searching for big data in real time and, more particularly, to a system for storing and searching for big data in real time, in which a large amount of data can be stored in a memory without a loss of data in real time in accordance with the generation of the large amount of the data, the large amount of data can be searched for in real time at the same time, the remaining old data can be stored in a Hadoop Distributed File System (HDFS) in a structured form by leaving only a given level of an amount in the memory, and the data can be rapidly searched for.

### 2. Description of the Related Art

Recently, as the distributed processing technology through a large number of clusters using a cheap server is suddenly developed, attempts to analyze a large amount of data that could not be stored and analyzed in a conventional technology are attempted at the same time. A data storage and analysis technology that requires explosive computing power for such a large amount or analysis ripples technologically and socially to the extent that a name denoted as a technology set separately called a big data technology is generated.

At the heart of distributed storage and distributed processing, that is, a core of such a big data processing technology, Hadoop, that is, an open source, and many software groups using the open source lead a technical trend.

Today the big data technology is basically divided and developed into streaming data clustering for real-time data analysis and batch clustering for rapidly analyzing a large amount of data. Particularly, as attention is focused on machine generated data such as a large amount of sensor data, data mining using streaming data clustering and machine learning has been in the spotlight.

However, since there are many technical problems to be solved, in many companies, various types of research are carried out on this field for technological preoccupancy.

As described above, the existing big data technology is developed in a form in which the technology is divided into two fields called batch analysis and real-time analysis and the two fields mutually supplement and compete with each other. However, in the situation in which requirements for real-time analysis and batch analysis are still mixed, a solution is not found in the big data research field. In the situation in which a big data platform needs to be applied to such an actual situation, a very complicated and uncertain architecture is inevitably selected.

Particularly, in the existing storage and distributed system based on Hadoop, the space for data storage has increased through clustering, but the collection of data that is actually generated in a large quantity is a field having many problems to be solved. A Hadoop Distributed File System (HDFS) that functions as the storage space of Hadoop can process the reading of data very rapidly through distributed processing, but requires separate software for data collection because the writing of data is relatively slow. Such software for data collection determines collection performance. Furthermore, in the analysis of collected data, if Hadoop is used, analysis of a batch form is easy, but analysis for immediate handling of a form corresponding to real-time requires separate analysis software due to a problem with a response time. It is not easy to satisfy the requirements for real-time analysis and batch analysis at the same time through a software architecture configuration at a current level of the big data technology due to such characteristics of Hadoop. A response speed for real-time analysis also does not meet a level that can be satisfied by a user.

A conventional technology suggested to store and search for data in real time is disclosed in <Patent Document 1> below.

The conventional technology disclosed in <Patent Document 1> is a data indexing method for real-time search performed in a computing apparatus. The data indexing method includes the steps of writing a document of a memory in a log file form, selecting a given amount of document including at least part of information read from the log file, generating at least one temporary segment for the document, exposing the at least one temporary segment to the search of a search engine, and generating a delete request file including the identifier of a corresponding delete candidate document if the document included in the at least one temporary segment is being merged in the state in which the at least one temporary segment has been exposed, and implements a data indexing method for real-time search.

### Prior Art Document

(Patent Document 1) Korean Patent No 10-1744017 (Jun. 7, 2017) (METHOD AND APPARATUS FOR INDEXING DATA FOR REAL TIME SEARCH)

However, the aforementioned conventional technology may provide a data indexing method for real-time search, but has a disadvantage in that it does not store, in a memory, big data that is generated in a large quantity in real time.

### SUMMARY

Accordingly, the present invention has been proposed to solve all the problems occurring in the conventional technology, and an object of the present invention is to provide to a system for storing and searching for big data in real time, in which a large amount of data can be stored in a memory without a loss of data in real time in accordance with the generation of the large amount of the data, the large amount of data can be searched for in real time at the same time, the remaining old data can be stored in a Hadoop Distributed File System (HDFS) in a structured form by leaving only a given level of an amount in the memory, and the data can be rapidly searched for.

In order to accomplish the above object, a system for storing and searching for big data in real time according to the present invention includes a data collection unit collecting data through a TeraStream BASS data source API (BDI) which is a data source library; a client searching for data through a TeraStream BASS client API (BCI) which is a client library; a data storage control unit dualized as a memory cluster for real-time data collection and a Hadoop cluster which is a disk storage space; and a data search and storage controller integrating and managing cluster configured in the data storage control unit, managing the data collection of the data collection unit, and managing results of the search so that the results are transmitted to a web or a user interface (UI) in response to a search request from the client.

In the above, the data search and storage controller previously allocates data to be used in each node of the memory cluster of the data storage control unit and directly stores, in the each node, data collected from the BDI.

In the above, the data search and storage controller divides a total memory to be used into a plurality of small memory blocks and processes a unit in which data is stored in an HDFS storage in the divided small memory block unit.

In the above, the data search and storage controller distributes and stores, in all nodes, data transmitted by one BDI and stores only data of one schema in one memory block.

In the above, in the data search and storage controller, when data search is requested using a BASS SQL through the TeraStream BASS client API (BCI), a master performs syntax checking on the data, transmits an SQL to all slave nodes, and performs the corresponding data search in indices of all memory blocks in which the corresponding schema has been stored based on the SQL.

In the above, in the data search and storage controller, when requested data search is accompanied by HDFS cluster search, a Map/Reduce program for data search is automatically generated, search is executed based on data of all the Hadoop clusters, and results of the execution are transmitted to the BCI.

In the above, the data search and storage controller and the client perform a server-client connection using a connector-adapter connection model, the connector is an object used by a client program when the client program accesses a server program, and includes a protocol for a login request, command transmission and response reception, and logoff notification, and the adapter is an object used by the server program when the server program receives access from the client program, and includes a protocol for login approval, command processing and response transmission, and logoff processing.

In the above, the data search and storage controller includes a master node host machine and a slave node host machine, and the master node host machine controls a slave node through an object called a slave map.

In the above, the slave map includes a set of slave descriptor objects in a lower level, and the slave descriptor directly communicates with the slave node based on reference to a slave adapter.

In the above, the master node host machine manages a periodic exchange of heart bits, a start-up/end/removal of a specific slave node, and an addition of a new slave node.

In the above, the data storage control unit manages memory blocks using an object called a memory map, and the memory map manages memory blocks using a queue and stack having reference to a pre-allocated memory block as an element.

In the above, the memory map checks a stack of memory blocks reference to all of the memory blocks has been stored in a free block stack, assigns a memory block, changes a state of the memory block to “BUSY”, increases a value called a holding count by 1, changes the state of the memory block to “FULL” when the memory block is full or a session in which data is transmitted is terminated, and registers reference to the corresponding memory block in a full block queue.

In the above, the BDI of the data collection unit and the BCI of the client directly access all slave nodes, and store collected data or search for stored data.

In the above, the data storage control unit performs data storage and search based on a storage section in which the BDI transmits data and a slave node stores data in a memory block and a query section in which the BCI transmits a query and receives retrieved data.

In the above, the data storage control unit stores data in an HDFS from old data in order to secure availability of a memory.

In the above, the data search and storage controller uses a producer-consumer model for data storage and search, the producer uses a structure in which data is buffered through an interface call, and the consumer uses a structure in which data is periodically checked in a buffer and the data is transmitted in bulk when the data is present, and transmits a large amount of data at a high speed through a periodic transmission model using the structure.

In the above, the periodic transmission model implements load balancing using a Round-Robin method.

In the above, the data search and storage controller improves data high-speed transmission performance by establishing several connections in one slave and increasing a degree of transmission parallelism.

In the above, the data search and storage controller prevents a data loss by separately writing an end of data finally transmitted by a consumer in a consumer thread and reading data inserted by a producer from a written location when subsequently reading data from an identical buffer unit.

In the above, the data search and storage controller searches for stored data using a linked B+ tree implemented by a leaf node as a double link for stored data search.

In the above, when insertion and search of data occurs, the data search and storage controller searches for a location into which data is to be inserted and a search location using binary search, and performs the binary search twice when searching the data.

In the above, the data storage control unit simultaneously generates an index file corresponding to a key value of data based on a file name into which a corresponding file is to be inserted when moving data in a memory to an HDFS.

In the above, the data search and storage controller performs HDFS search in such a manner that an index value matched with a query sentence condition requested by a user with respect to a predefined indexed column is searched for using Map/Reduce and an input formatter collects raw data and querying index results based on generated results and generates input splits necessary for the Map/Reduce.

According to the present invention, there are advantages in that a large amount of data can be stored in a memory without a loss of data in real time in accordance with the generation of the large amount of the data, the large amount of data can be searched for in real time at the same time, the remaining old data can be stored in the HDFS in a structured form by leaving only a given level of an amount in the memory, and the data can be rapidly searched for by providing the hybrid storage and search system using distributed memory storage and the HDFS as a storage at the same time.

### BRIEF DESCRIPTION OF THE DRAWINGS

FIG. 1 is a general structure diagram of a system for storing and searching for big data in real time according to the present invention.

FIG. 2 is a structure diagram of a cluster in FIG. 1.

FIG. 3 is a data flow structure.

FIG. 4 is an exemplary diagram of a communication structure.

FIG. 5 is a remote execution procedure diagram using an SSH.

FIG. 6 is a structure diagram of command processing.

FIG. 7 is a structure diagram of command processing and slave node management.

FIG. 8 is an exemplary diagram of a memory map management system.

FIG. 9 is a configuration diagram of a slave direction connection between a BDI and a BCI.

FIG. 10 is periodic transmission architecture.

FIG. 11 is an exemplary diagram of session multiplying and load balancing.

FIG. 12 is an exemplary diagram of a data loss attributable to context switching.

FIG. 13 is an exemplary diagram of the prevention of a data loss.

FIG. 14 shows the results of a transmission speed change according to the number of sessions.

FIG. 15 is a structure diagram of a common B tree.

FIG. 16 is an exemplary diagram of an insertion process of a B tree.

FIG. 17 is an exemplary diagram of a B+ tree.

FIG. 18 is an exemplary diagram of an insertion process of a B+ tree.

FIG. 19 is an exemplary diagram of a linked B+ tree structure.

FIG. 20 is exemplary data.

FIG. 21 is an exemplary diagram in which each indexed tree has been linked in the linked B+ tree.

FIG. 22 is an exemplary diagram of a process of inserting data 27 into the linked B+ tree.

FIG. 23 is an exemplary diagram of a process for searching the linked B+tree for data 20.

FIG. 24 is an exemplary diagram of an HDFS data set.

FIG. 25 is an exemplary diagram of an HDFS data set assuming that desired data has gathered at the front of a No. 1 file.

FIG. 26 is a comparison diagram of the HDFS Indexing of FIGS. 24 and 25.

FIG. 27 is an exemplary diagram of building indexing of TeraStream BASS.

FIG. 28 is an exemplary diagram of full searching of a TeraStream BASS.

FIG. 29 is an exemplary diagram of indexing searching of the TeraStream BASS.

FIG. 30 is an overall speed monitoring table according to the number of nodes.

FIG. 31 is an overall speed graph according to the number of nodes.

FIG. 32 is a speed monitoring table for each node according to the number of nodes.

FIG. 33 is an overall speed graph according to the number of nodes.

FIG. 34 is an exemplary diagram of insertion performance results.

FIG. 35 is a diagram of search performance results.

FIG. 36 is an exemplary diagram of the specifications of a Hadoop Namenode.

FIG. 37 is an exemplary diagram of the specifications of a Hadoop DataNode.

FIG. 38 is a diagram of Compare No Index and Index Test results.

FIG. 39 is an exemplary diagram of Compare No Index and Index Test data.

### DETAILED DESCRIPTION

Hereinafter, a system for storing and searching for big data in real time according to a preferred embodiment of the present invention is described is detailed with reference to the accompanying drawings.

The system for storing and searching for big data in real time according to the present invention has a dual cluster in which the cluster structure of the system consists in a memory cluster for real-time data collection and a Hadoop cluster for disk storage space. Furthermore, the system has a structure in all clusters are integrated and managed by a main Daemon, and has a structure in which data is collected from a data source through the main Daemon and analysis results are transmitted to a web or a UI through a client.

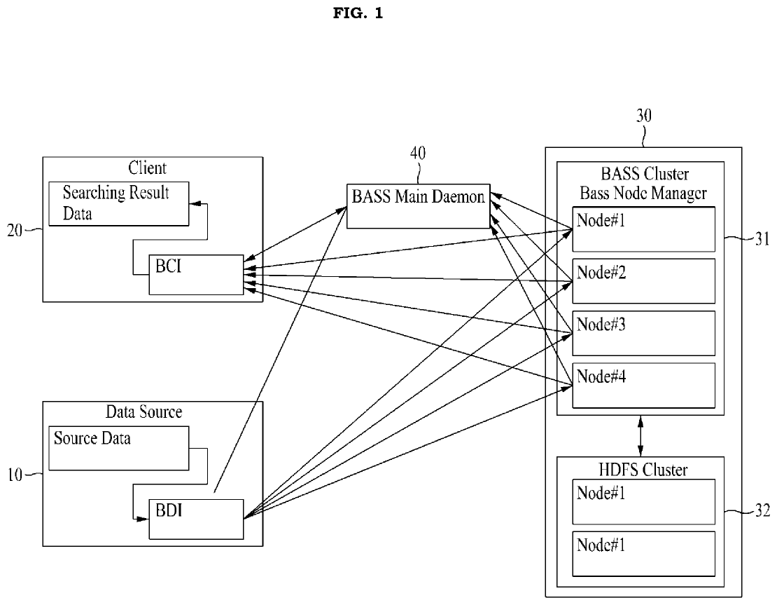

FIG. 1 is the structure of a system for storing and searching for big data in real time (hereinafter abbreviated as a “TeraStream BASS”) according to the present invention. The system has an external structure in which the collection and search of data are performed through a BCI, that is, a client Library, and a BDI, that is, a data source library. A BASS cluster and an HDFS cluster are logically divided, but may be physically configured with the same cluster. The HDFS cluster has been designed to be configured as a separate cluster by increasing the number of nodes of the HDFS cluster depending on the amount of data. The reason why the HDFS cluster is designed as such architecture is that it can handle a user's requirements more flexibly if the HDFS cluster is configured as a separate cluster because it may be impossible to construct the amount of data to be stored in a memory and the amount of data to be stored in the HDFS using the same cluster.

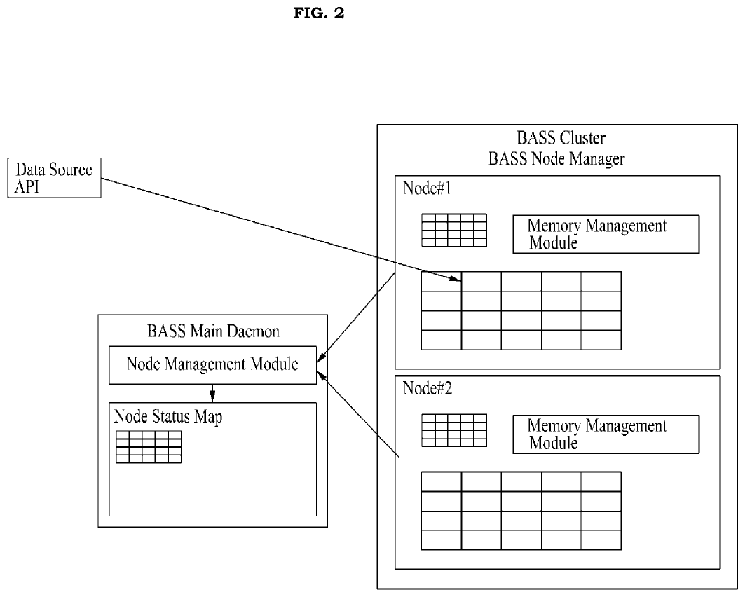

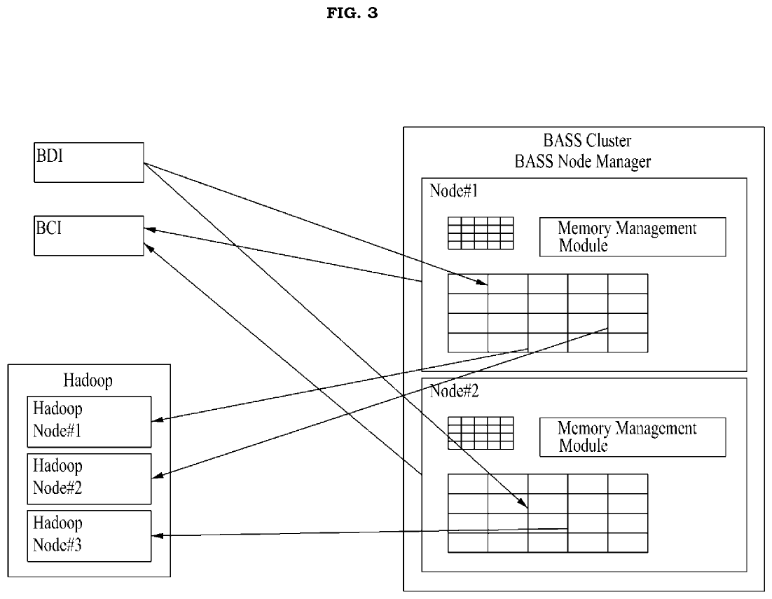

FIG. 2 is a cluster structure applied to the system for storing and searching for big data in real time. The cluster structure is a structure in which data to be used for each node is previously allocated and data collected from the BDI of a data collection unit 10 is directly stored in a node because data is basically distributed and stored in the memory. In the present invention, unlike in Hadoop, data is not redundantly stored in preparation for a node failure, and only one data case is present in one node. In the present invention, a memory to be used is not managed as one large memory, but is divided into small memory blocks and managed. The reason for this is that a task for moving the data of the memory to the HDFS is necessary in order to maintain the availability of the memory because the capacity of the memory is limited. In this case, if the entire memory is managed as one, all nodes necessary for HDFS storage become unavailable. In order to avoid such a problem, a unit in which data is stored in the HDFS is processed as a memory block unit. Although a process of storing data in the HDFS is performed, the remaining memory blocks of the memory continue to perform data storage.

A process of collecting data in real time under the control of a data search and storage controller 40 is as follows.

The TeraStream BASS has a form in which two methods of directly collecting data from the data source or collecting data through an agent can be used. However, a TeraStream BASS data source API called the BDI must be used in the two methods. That is, data is transmitted to the TeraStream BASS using a method of directly transmitting, by the data source, data to the TeraStream BASS through the BDI or developing an agent and collecting, by the agent, data and transmitting the collected data to the TeraStream BASS through the BDI.

The data transmitted through the BDI experiences a process of being stored in the BASS cluster 31, that is, the memory cluster of the data storage control unit 30, and the HDFS cluster 32 of Hadoop. Basically, the collected data is primarily stored in the memory cluster 31 of the TeraStream BASS. The data is transmitted to one memory allocated in a BASS Slave node, but one memory block is allocated to all nodes in all clusters. Accordingly, data transmitted through one BDI is distributed and stored in all the nodes, and only the data of one schema is stored in one memory block.

A data search process based on a request from the client 20 is described below.

Search for data is performed through the TeraStream BASS client API (BCI). When a user requests data search using a BASS SQL through a web or a command, the request first experiences syntax checking in a master and is transmitted to all slave nodes. The request is transmitted to all memory blocks in which a corresponding Schema has been stored depending on a transmitted SQL. Corresponding data search is performed in the index of each memory block.

Furthermore, if the request data search is accompanied by HDFS search, the data search is requested from the Hadoop cluster (HDFS cluster). In this case, a Map/Reduce program for the data search is automatically generated. The search is performed based on all the data of the Hadoop cluster, and results thereof are transmitted to the BCI.

A communication structure for the transmission of retrieved result data is described below.

In a structure in which multiple execution modules are connected over a network and operate, it is important to use a single server-client connection model in safety and maintenance viewpoints. The BASS also uses such a model, which is named a connector-adapter connection model.

The connector is an object used when a client program accesses a server program, and implements a protocol for a login request, command transmission and response reception, and logoff notification.

The adapter is an object used when the server program receives access from the client program, and implement a protocol for login approval, command processing and response transmission, and logoff processing.

The connector and adapter of each of the peers (BDI, BCI, ADMIN, master, slave) of the BASS is basically extended and implemented based on its role.

Although there is an adapter model for a single connection, the server requires a model for safely and efficiently managing multiple adapters. Commonly used connection management models include Select, Fork, Thread Creation, a Pre-forked connection pool, and a Thread based connection pool.

First, the Select model is a method of processing, by a single thread of a single process, all connections using an input/output multiplexing system call, and is not suitable for a system, such as the BASS in which connections must be processed in parallel (because complicated logical processing or the exchange of large packets is frequent).

The Fork method and the Thread-creation method are a method of generating a corresponding new process or thread when a new connection occurs, and have a danger that a connection may fail when due to a resource problem in the present invention in which the amount of system resources used is much.

The Pre-forked connection pool is a method of producing a pre-designated number of processes for connection processing. The Pre-forked connection pool has advantages in that a fixed resource can be previously secured for connection processing and the entire Daemon is not affected although a problem, such as memory invasion or wrong signal processing, occurs in a specific connection, but it requires a shared memory due to the characteristic of the present system in which each process must frequently access a common memory region. The shared memory has problems in that control thereof is difficult and has a slightly slow speed compared to common memory processing.

Finally, the Thread based connection pool is a method of producing a pre-designated number of threads, and is the same as the Pre-forked method in that a fixed resource can be previously secured for connection processing, but has a danger in that a problem occurring in a specific connection may cause the abnormal termination of the entire Daemon. The Thread based connection pool has an advantage in that memory data can be controlled rapidly and flexibly. Threads within one process use the same memory region.

In the BASS, the lastly described Thread based connection pool method has been adopted. The reason for this lies in the fast and flexible control of memory data. Considering that the core function of the BASS is data processing in a memory, the fast and flexible control of memory data is a characteristic that needs to be foremost. Furthermore, although the Pre-forked method is theoretically more stable, it is a matter of no great import because, for an actual Daemon program, multiple thread codes are necessarily included in any form although it is not connection management.

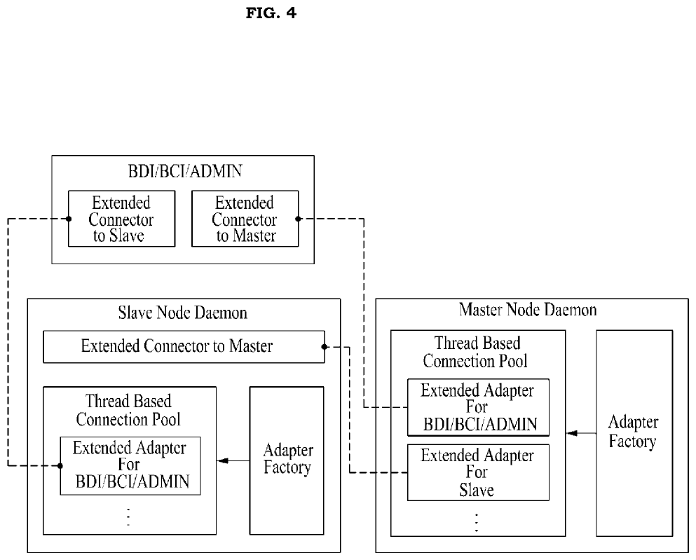

Separately from the conceptual architecture, architecture in a communication viewpoint is diagrammed like a form, such as FIG. 4.

All BDI, BCI, and ADMIN are client programs, and each requests a connection using an extension connector for accessing a master and a slave.

Both the master node and the slave node are server Daemons, and have Thread based connection pools. When a new connection occurs, the node generates a suitable extension adapter from the Adapter Factory based on a Factory pattern, allocates the extension adapter to a connection pool, and activates a corresponding thread. In this case, a specific point is the presence of a connector owned by the slave node. The reason why the slave node must have the connector although it is a server Daemon is that the slave is also one client from the viewpoint of a master. As described above, in order to process the server-client connection relation using the same model, the connector object is implemented in such a way as to be included in the slave node. ADMIN does not directly access the slave. In order to facilitate the understanding of the communication model itself, ADMIN has been illustrated in the drawing along with the BDI and BCI.

The system of a cluster structure needs to start up and terminate Daemons installed in different machines in a lump. In the case of a batch end, one Daemon may receive the end command of a user and transmit it to another Daemon, which is not applied to the case of start-up.

In order to solve this problem, the BASS starts up clusters in a lump using an SSH. The SSH service is basically mounted on all UNIX/LINUX systems and is also used in a Hadoop framework.

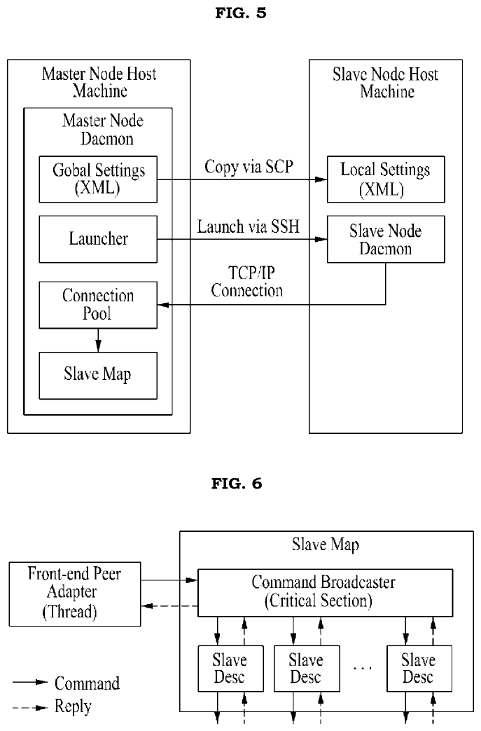

FIG. 5 describes a procedure of starting up a Daemon at a remote place using the SSH. When a user starts up a master Daemon, a master node loads, onto a memory, environment information written in an XML form. The environment information has all pieces of information necessary for the start-up of a slave Daemon including the location of each slave Daemon. The pieces of information are copied to a host machine at a remote place via an SCP. Furthermore, when a start-up command is transmitted through an SSH, the slave Daemon is executed. The slave Daemon performs initialization based on the copied environment information and accesses the master node. In this case, the master receives the access of the slave through a pre-generated connection pool, and registers the corresponding information with a slave map for slave control, thereby completing the start-up procedure.

To this end, a No. 22 port, that is, an SSH base port, must be open. An RSA key exchange must be previously performed between host machines configured as clusters.

From a user viewpoint, to use software is a behavior of issuing a command and receiving results thereof. Steps in which the BASS performs a user command are as follows.

The steps include a process in which the master node receives a command->the master node transmits the command to the slave node->the master node and the slave node perform a function->the slave node transmits results to the master node->the master node collects the results->the master node transmits the results.

In order for several Daemons distributed at remote places to perform one function in association, an implementation of a function itself is important, but a structure in which commands and responses are exchanged between the Daemons and results are collected is also just as important.

As described in the batch start-up description, the master node controls the slave node through an object called a slave map. The slave map has a set of lower slave descriptor objects. The descriptor directly communicates with the slave node using reference to the slave adapter.

When a user, that is, the connector of a front-end peer, transmits a command to a corresponding adapter of the master node, the adapter requests the slave map to broadcast the same command. A broadcaster within the slave map transmits the command through each descriptor, collects arrived responses, and returns them to the adapter. In this case, it is important that a broadcaster region is protected by a critical section because several adapters operate as independent threads.

The master node uses the slave map for the management of the slave node in addition to command processing. The management function of the slave map is as follows.

The management function includes a periodic exchange of heart bits, the start-up, termination and removal of a specific slave node, and the addition of a new slave node.

The heart bit exchange has a structure in which an independent thread responsible for only the heart bit exchange is placed within the slave map, and the thread autonomously transmits a heart bit command to the slave node and receives a corresponding response. The state of the slave node is used to check whether a communication connection state is abnormal, whether a memory block is available, and whether actual validity is abnormal. A heart bit sensor interprets a response from the slave node and updates state information of a corresponding descriptor.

The termination of the slave node is performed by only a command from the ADMIN, and is performed according to the method described in the command processing process. When a specific slave node is terminated, the state of a corresponding descriptor is updated with a connection break.

The start-up of the slave node is a management function which is used for a slave that already has a descriptor, but has a state of “connection loss”. In an actual use environment, the start-up of the slave node corresponds to an intentional re-start-up and a case where a slave Daemon is abnormally terminated unintentionally. Start-up is also configured with only a command from the ADMIN, and a processing procedure thereof is the same as the contents described in “batch start-up”.

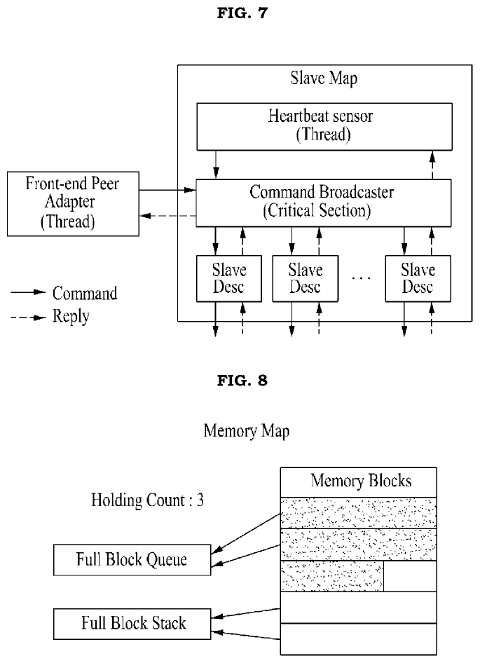

Addition and removal are possible through only an ADMIN command. If a slave node is added, a slave map generates a new descriptor, adds the descriptor it to a list, and automatically performs remote start-up through the added descriptor. If the slave node is removed, the slave map performs an end command through a target descriptor and removes the slave node from the descriptor list. A command processing structure including a slave node management viewpoint, such as FIG. 6, may be drawn again like a form, such as FIG. 7.

A memory management process of the data search and storage controller 40 and the data storage control unit 30 is described as follows.

A memory block is managed by an object called a memory map. The memory map gives an idle memory block if it has the corresponding block, and continues to search for an idle block until the idle block occurs if it does not have the idle block. The memory map manages memory blocks using a queue and stack having reference to a pre-allocated memory block as an element. FIG. 8 is a diagram describing how the memory map manages a memory block.

Upon start-up, reference to all memory blocks is registered with a Free Block Stack. The memory map checks the stack and assigns a memory block. In this case, the memory map changes the state of the memory block to “BUSY”, and increases a value called a holding count by 1. Furthermore, if the memory block is full or a session for transmitting data is terminated, the memory map changes the state of the memory block to “FULL”, and registers reference to the corresponding memory block with a full block queue.

Blocks registered with the full block queue are managed by an archiving procedure configured with two steps.

Whether a value of the holding count has reached a threshold value is periodically checked. When the value reaches the threshold, blocks registered with the full block queue are archived until the value reaches a lower limit.

The threshold and the lower limit values are represented as a percentage for a total number of memory blocks. A test criterion is a value obtained by converting the number of memory blocks used not the amount of a memory used into a percentage. The holding count is a value of the sum of the number of memory blocks that are being used and the number of memory blocks that have been fully used as described above. The number of blocks that are being used may not reach the lower limit, and archiving may be terminated. The reason why such a structure is adopted is that uniform performance can be achieved compared to a case where the number of full blocks is used as a criterion because memory blocks that are being used function as a buffer for a reception bottleneck.

A block that has been archived is excluded from the data storage component list of a schema to which the block belongs, and returns back to the free block stack of the memory map.

There are reasons why a full block is managed as a queue and an idle block is managed as a stack. First, a full block is suitable for a queue structure because it needs to be stored in order of registration. In the case of an idle block, a stack structure was adopted for a slight complicated reason. At the early stage of development, much time was taken to first assign a memory block and prepare an index object. Accordingly, the stack structure was adopted because the time taken to prepare an index object can be stochastically reduced if a memory block that has been used once is immediately taken out and used. However, today, the stack structure is a structure not having a special meaning through the improvement of an index object.

A storage section refers to a section in which the BDI transmits data and the slave node stores the data in a memory block. Such a procedure is slightly complicated and listed as follows.

The procedure includes a procedure in which the BDI logs on to the master->the master transmits slave access information to the BDI->the BDI logs on to all slaves->the BDI designates a schema in which data will be stored->the slave node allocates a memory block and binds the schema->the BDI transmits the data->the slave node copies the data to the memory block->the slave node indexes the data->when the memory block is full, a new memory block is allocated and a schema is bound->the BDI notifies the completion of transmission.

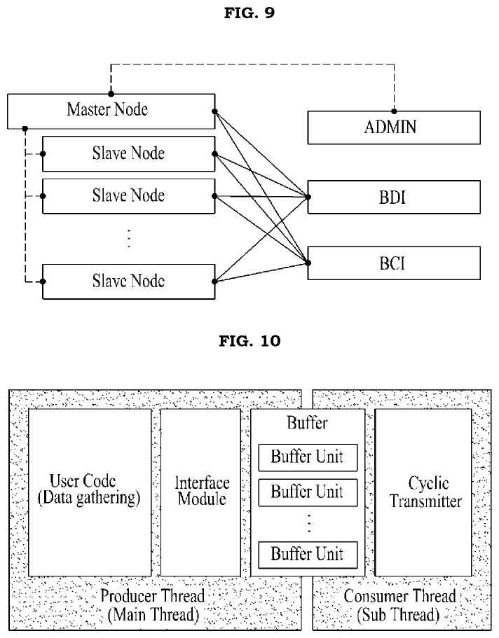

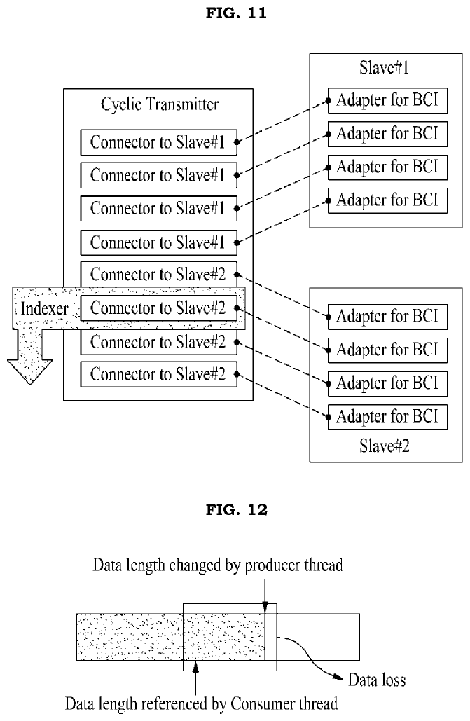

A data storage procedure starts when the BDI accesses the master. When data is stored, the BDI directly accesses all slave nodes. The reason is simple. The reason is as follow. If the master node relays data between the BDI and the slave, a bottleneck occurs. As will be described later, when the BCI queries data, the same structure is used for the same reason. The ADMIN is excluded because it does not have data communication. FIG. 9 shows the slave direction connection structure of the BDI and the BCI.

As shown in FIG. 9, when access is completed, the BDI notifies that data transmitted by the BDI needs to be stored in which schema. The slave checks whether a corresponding schema is present, and notifies the BDI of a result of the check. Fullscale data transmission is started from this moment.

An operation first performed by the slave node when it receives data is to check whether a memory block in which data is now written is present. If not, the slave node requests memory block allocation from the memory map. When a new memory block is allocated, the slave node internally generates one index object, and calculates a minimum number of cases that may be inserted into the memory block based on the data format of a corresponding schema. Furthermore, the slave node registers the memory block with the data storage component list of the corresponding schema. A series of such processes are called binding. Whether the memory block is full is determined based on the minimum number of cases not the size of data that has been actually inserted. If a data length has a great deviation, the data may be slightly lost in a memory availability viewpoint, but stability damage which may be accompanied by the companion processing of already returned data can be avoided and a great gain in a performance viewpoint can be expected because an index object can be previously generated as a fixed size. The index object has a very complicated structure. If the index object is flexibly generated depending on a data storage situation, performance may be severely degraded to the extent that the index object cannot be used.

After the binding is completed, the memory copy and indexing of the received data are performed. When the memory block is full, the allocation of a memory block is repeated again.

A query section refers to a section in which the BCI transmits a query and receives retrieved data. As in the storage section, this procedure is performed slightly complicatedly and is sequentially list as follows.

The procedure includes a procedure in which the BCI logs on to the master->the master transmits slave access information to the BCI->the BCI logs on to all slave nodes->the BCI transmits a query to the master->the master node checks the validity of the query->the master node transmits schema information to the BCI->the master node prepares a result set object of the BCI->the BCI transmits the query to each slave node->the slave node checks data->the slave node transmits the data->the slave node notifies the end of the data.

The query of the BCI has a form similar to the Select of an SQL, and a range in a function thereof is as follows.

Basically, the query is similar to the select query of a database

select * from <schema_name> where <condition paragraph>

select <col_name>, <col_name> . . . <col_name> from <scheama> where <condition paragraph>

A supported condition operator: <, >, <=, =>, =, !=, between, and, or, a combined parenthesis.

A condition may be assigned to a column, designated as a key, to the schema. In the future, the designation of a condition using a full-scan method may be supported for a column not a key. Whether the designation will be supported has not been determined, and Join, group by, an aggregate function, etc. are not supported.

Only a complex condition for a single schema is supported. That is, only one schema may be placed in a from paragraph.

In the case of a batch type service such as a day unit or month unit batch, the fetching of data from only a region stored in the HDFS is supported.

A real-time service or a showing-focused service having a semi-real-time property is supported so that data can be fetched from only a region stored in a memory.

The transmitted query is analyzed by a query parser based on lex-yacc. Data search and transmission are performed using a Parse-tree object configured with analysis results. Synchronization has been performed so that a schema that is being queried can be stored at the same time.

A transmission speed upon data query is very lower than a transmission speed upon data storage. The reason for this is that the BDI maximizes the transmission speed through a very complicated multi-threading model and the slave transmits data as a single thread when transmitting the data to the BCI. This includes two reasons. First, when a user accesses data using the BCI, bulk transmission is meaningless because the user uses a fetch structure like a database API. Second, the slave side cannot maintain a CPU share in a high state for high-speed transmission because it does not know how much tasks will a BCI application program perform on one data.

In HDFS archiving, in order to secure the availability of a memory block, a memory is secured by storing data in the HDFS from old data. A series of such procedures is called the HDFS archiving. The HDFS archiving operates based on the setting of the TeraStream BASS main Daemon (data search and storage controller), and a related setting value is as follows.

BASS.Slavethe node.Archiving.Enablement

BASS.Slavethe node.Archiving.Interval

BASS.Slavethe node.Archiving.Threshold

BASS.Slavethe node.Archiving.LowerLimit

Enablement is a setting value to determine whether to perform archiving. A basic value is true. When the value is set as false, HDFS archiving does not operate, and operates in a pure memory distributed mode.

Interval is a period in which the state of a memory block is checked, and a unit thereof is a second. For example, when the interval is set to 3, the number of full memory blocks is checked every 3 seconds, and whether to start an archiving procedure is determined.

Threshold is a memory share at which archiving starts its operation, and a unit thereof is %. For example, when the threshold is set to 80, archiving starts if 80% of all memory blocks is full.

Lower Limit is a memory share at which archiving is stopped, and a unit thereof is %. For example, if the lower limit is set to 50, when archiving starts, the archiving is stopped when the number of full memory blocks becomes 50% of a total of memory block.

A method of performing archiving is performed using a put method of the Hadoop. The index of the TeraStream BASS is also converted along with data based on HDFS Searching and is stored. In the execution, one put operates every slave node of the TeraStream BASS. That is, if all slave nodes of the TeraStream BASS are 10, a maximum of 10 archivings may be performed. If the speed of stored data is faster than 10, delay may occur in data collection. Accordingly, the setting value and the number of slave nodes need to be determined based on a maximum HDFS storage speed and data collection speed.

The archiving location of the HDFS has now been determined, and uses /bass of a Root Directory. If a corresponding directory is not present, a directory necessary when archiving first occurs is automatically generated. The TeraStream BASS performs archiving for each schema, that is, a storage unit of data. An archiving location is separately determined for each schema. Contents stored for each path on the HDFS are as follows.

/bass/[schema_name]/data: Actual data

/bass/[schema_name]/index: Index data

/bass/[schema_name]/tmp: Temporary space

bass/[schema_name]/tmp/select_[select_ID]: Select results

Next, HDFS Searching means that the data of the HDFS is searched for after memory searching is completed if results need to include data stored in the HDFS when a user requests a data query through the TeraStream BASS client.

HDFS Searching operates only in a Select sentence of the SQL. HDFS Searching operates only when “ON DISK”, “ON DUAL” is included in the SQL. HDFS Searching is a method basically using MAP/REDUCE of the Hadoop. If HDFS Searching occurs, java source code generation and compilation are accompanied because a Hadoop MAP/REDUCE Job is generated. This task is performed in a slave node, and is performed in one of slave nodes.

When HDFS Searching is requested, a procedure of generating and moving data is as follows.

\textcircled{1} CD Index data suitable for a search condition is selected in /bass/[schema_name]/index and generated in /bass/[schema_name]/tmp/index_[select_ID].

\textcircled{2} Only a file corresponding to select results is searched for in /bass/[schema_name]/data using the generated temporary index, and the final results are stored in/bass/[schema_name]/tmp/select_[select_ID].

\textcircled{3} The stored final results are transmitted to a user.

A technology for transmitting a large amount of high-speed data in the BASS is a solution to the following special producer-consumer model.

The producer unlimitedly generates a small amount of data, and the consumer transmits data through a TCP/IP. Target performance is 10 Gbits/s or more, and buffering is essential because the size of one data case is small. Since the end of the data is unknown, the consumer needs to be able to transmit data even in the state in which a buffer has not been full when a bottleneck occurs on the producer side.

Detailed schemes applied to solve such a problem are described.

Practically, all other requirements can be solved by a simple buffering and multi-threading scheme, but the last requirement is important. If the end of data can be known, the data is buffered until a buffer is full, and is transmitted. The last data is merely transmitted. However, in the situation in which data is unlimitedly generated, the consumer cannot be aware of whether the state in which data is not received is the end of the data or means a temporary bottleneck of the producer. In order to solve such a problem, in the BASS, periodic transmission architecture, such as FIG. 10, is applied.

In general, the size of business data for each case is not so great. If such data is transmitted for each case, the time taken for a transmission system call is excessively increased. Accordingly, buffering for accumulating data in a buffer and transmitting the data when a given amount of data is reached is essential. However, as described above, if the end of data cannot be known, it is necessary to transmit the data on the consumer side although the buffer is not filled with data. Such a problem is solved by implementing a structure in which data is buffered through a common interface call on the producer side and implementing a structure in which a buffer is periodically checked and data is transmitted in bulk if the data is present on the consumer side. In order to minimize real-time damage according to periodic processing, a transmission cycle is set to 100 ms ( 1/10 second). Furthermore, while transmission is performed in one buffer, the producer divides the inside of the buffer into small units so that data can be inserted into another buffer and manages the buffer. Such a structure is a structure which reduces the number of transmission system calls using a buffering scheme and satisfies a condition in which data transmission needs to continue although a buffer is not full.

Another characteristic of the present invention is to promote performance improvement through session multiplying. As a method for achieving target performance, this is a method of increasing a degree of transmission parallelism by establishing several connections for one slave. The slave processes each of the connections as an independent thread. When data is received at a time in bulk, a significant time is taken for memory copy and indexing. If data can be received through another connection at this timing, performance improvement according to parallel processing can be obtained that much. Currently, four connections are fixed to be open for each slave.

A load balancing scheme used in a high-speed transmission module adopts a simple Round-Robin method.

A periodic transmission module internally has reference to the slave connector. If the number of slave nodes is two, there are a total of eight connectors by session multiplying. The periodic transmission module finds a next connector of a connector through which data has been finally transmitted whenever the module wakes up, and transmits the data of a buffer. Accordingly, all connections for all slave nodes uniformly transmit and receive data.

As can be seen from FIG. 10, the critical section of the transmission module is a buffer region. This is the same even in a common producer-consumer model, and the synchronization problem of the buffer region may be said to be practically the core of this communication model. In this case, a common synchronization scheme could not be adopted, and a reason thereof is as follows.

A Mutex and Condition-variable scheme has a structure in which a routine in which data is input is unexpectedly executed by a user's call and a data transmission thread operates by only this call. Accordingly, if the Mutex is used, a combination with a condition-variable is essential. However, due to the characteristic of this project to minimize real-time damage, a very frequent synchronization function call is inevitable. The time taken to execute the synchronization function is off-the-scale. This is an alternative which cannot be adopted in a program of a form, such as the communication module.

Various lock-less algorithms based on an atomic operation is a methodology for significantly reducing a context-switching cost, that is, a disadvantage of the traditional synchronization methodology. However, if atomic-write is frequent, this becomes a factor of performance degradation because the cache line of all processors that watch the same lock continues to be invalidated. Furthermore, in a program of a form, such as this communication module, a CPU share remains in a state of 100% for most of the execution time.

A sleep-signal method never showed performance.

Accordingly, there is only a method of checking a flag declared as a volatile variable within a loop. A volatile keyword means that a corresponding variable will be always directly read from a memory region not a CPU cache and written. This prevents a compiler and a value different from a developer's intention from be referred by the code optimization of a CPU.

As in the lock-less algorithm, the method has a problem with a CPU share, but it is free in cache consistency and has an easy implementation. Furthermore, since a lock variable is hidden within a library, it is free from interference attributable to context. A synchronization scheme of a method similar to this method has been used in TeraSort.

Each buffer unit has a readable flag indicating whether read is possible and a writable flag indicating whether write is possible. The state of timing at which a program is executed is a state in which both read and write are possible.

When data is generated, the producer checks whether there is a writable buffer unit, and changes the state of the corresponding buffer unit to a read-impossible state. Thereafter, the producer copies the data to a buffer, and changes a value of an integer type variable that writes the end of the data. Finally, the producer changes the state of the buffer unit to a readable state and changes the buffer unit to a read-impossible state if the buffer unit has been full.

The consumer starts from wake-up while sleeping for 100 ms. Like the producer, the consumer checks whether there is a readable buffer unit, and changes the state of the corresponding buffer unit to a write-impossible state. Thereafter, if stored data is present, the consumer transmits data corresponding to a size, and changes the state of the corresponding buffer unit to a writable state.

Such an algorithm has one problem in that a routine for checking one variable and changing a value of the other variable cannot be protected as a critical section. If context switching occurs while a consumer thread checks a readable flag and tries to change a writable flag, the producer pushes data, and the consumer transmits data corresponding to a previously written size. Accordingly, some of data may be discarded as in FIG. 12. This is a problem rarely occurring in an extreme load situation. Such a phenomenon does not actually occur in common data transmission and reception having a sufficiently slow speed. However, in this communication module, the problem must be solved because an extreme situation is assumed from the first.

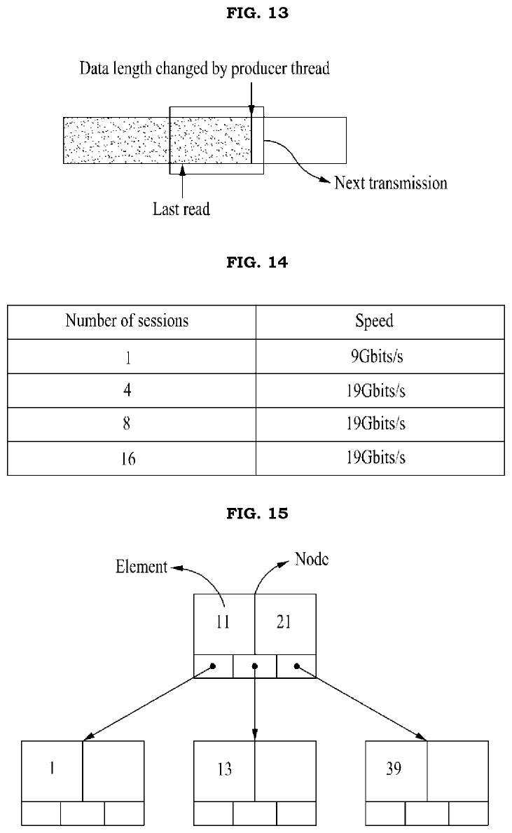

In order to prevent such a situation, one device is further provided. As shown in FIG. 13, the end of data finally transmitted by a consumer in a consumer thread is separately written. Accordingly, when the data is next read from a buffer unit, a data loss can be avoided by reading data from the written location up to data inserted by the producer.

FIG. 14 shows the results of the test of pure transmission performance for the communication module only. The test was performed in the following environment, and results thereof are shown in FIG. 14.

A hyper thread 8 core (32 thread) was used as a host machine. In order to avoid restrictions to a network band, both the transmission side and the reception side were executed in one host, and data of 105 bytes was transmitted a total of a billion times.

A speed of 9 Gbits/s approximate to target performance is achieved by only a single session. A maximum speed of 19 Gbits/s is reached by only four session. This means that the communication module does not become a bottleneck section and the time taken for data processing logic can be compensated for a certain extent in an actual network environment.

A data index technology of the TeraStream BASS is a linked B+ tree modified from a B+ tree in a form suitable for the TeraStream BASS. First, the existing B tree-series index method is introduced, and the linked B+ tree technology is introduced through a comparison.

FIG. 15 is a B tree of the most basic form.

A given number of elements form a node. A node constructed as above is linked through the re-distribution algorithm of a B tree, so the B tree is generated.

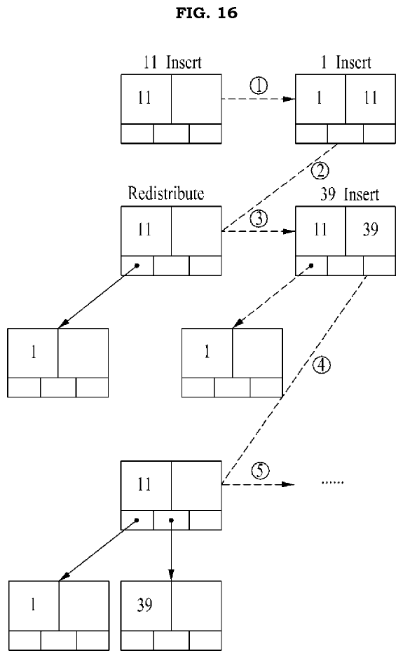

FIG. 16 describes which operation is performed internally when data is inserted into the B tree.

In the B tree, a maximum number of elements which may be permitted in each node are defined as a degree. The degree is determined before a tree is generated. The elements of each node are always maintained in ascending order. In an insertion process, when the number of elements of a node becomes a maximum, re-distribution occurs. Accordingly, a maximum number of elements of each node in the B tree cannot exceed a degree −1.

Since such a process occurs, insertion performance is slightly low compared to a BST-series index, but there is not deviation in performance even in a specific set of data because a balanced tree is guaranteed.

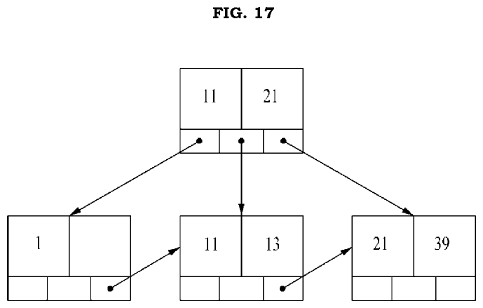

As shown in FIG. 17, the B+ tree is similar to the B tree, but the node of the lowest depth of the tree is defined as a leaf node and is defined as a node for actual search. The remaining nodes are defined as inner nodes and are divided as node for pure data index only and operate.

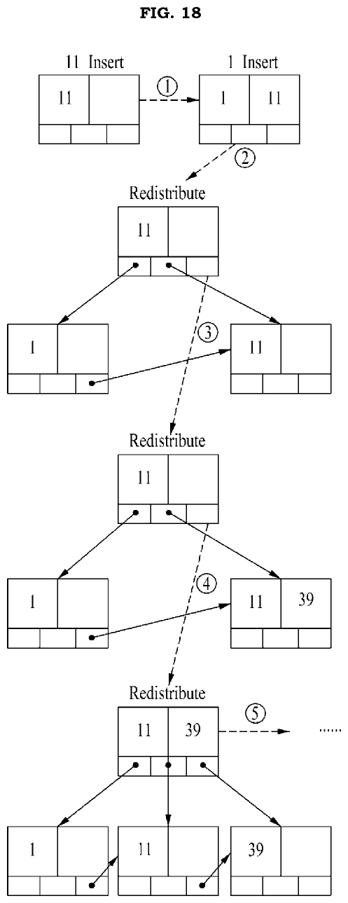

FIG. 18 shows that which operation is internally performed when data is inserted into the B+ tree.

The operation of the B+ tree is basically similar to the insertion operation method of the B tree. A difference is that if data is inserted and it is determined that the data needs to be re-distributed, data present in a leaf node, that is, a re-distribution target, is copied to an inner node. Furthermore, leaf nodes sequentially form a single link. Accordingly, a memory is wasted as much as copied data space compared to the B tree, but search performance is much excellent due to leaf node that sequentially form a single link.

The B+ tree has memory waste compared to the B tree, but the memory waste is a negligible level when the TeraStream BASS is considered to be a distributed processing system. Furthermore, since real-time search performance is also important as much as memory storage performance, a linked B+ tree technology optimized for the TeraStream BASS was developed using the B+ tree.

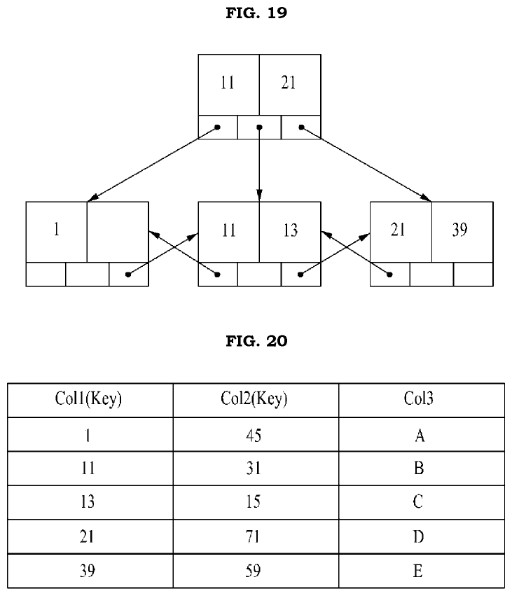

FIG. 19 is a basic form of the linked B+ tree.

If leaf nodes of the B+ tree sequentially form a single link, the linked B+ tree is doubly linked. This is a scheme added for the usage of the search engine of the TeraStream BASS and does not affect performance or memory use when data is stored. Through this scheme, a function, such as ascending order/descending order search of data can be easily implemented.

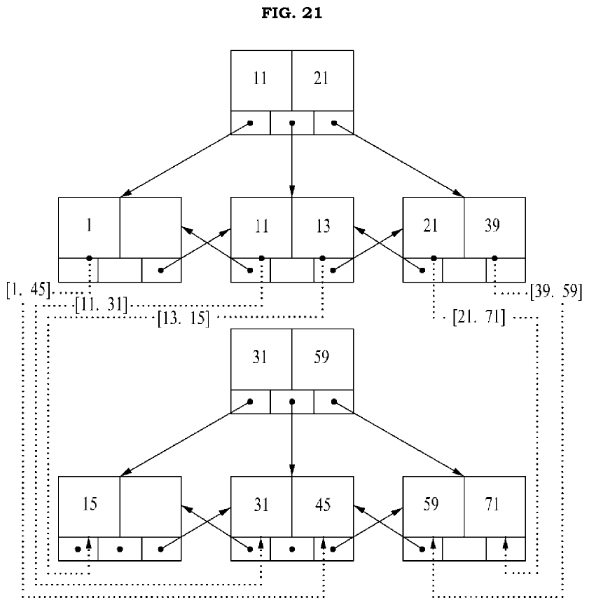

FIG. 21 is a diagram showing the structure of the linked B+ tree when the number of index keys necessary for data is 2 (refer to FIG. 20). The TeraStream BASS needs to maintain a real-time property and to enable search although multiple index key for data are present.

An index is independently generated based on each key, but the keys of the same record are connected by a separate link. Accordingly, if search is performed based on complex condition using different keys, rapid search using an index not full search is possible.

In a linked B+ tree, binary search is used when the insertion and search of data occurs.

Binary search is advantageous because a B tree-series index characteristic is included without any change.

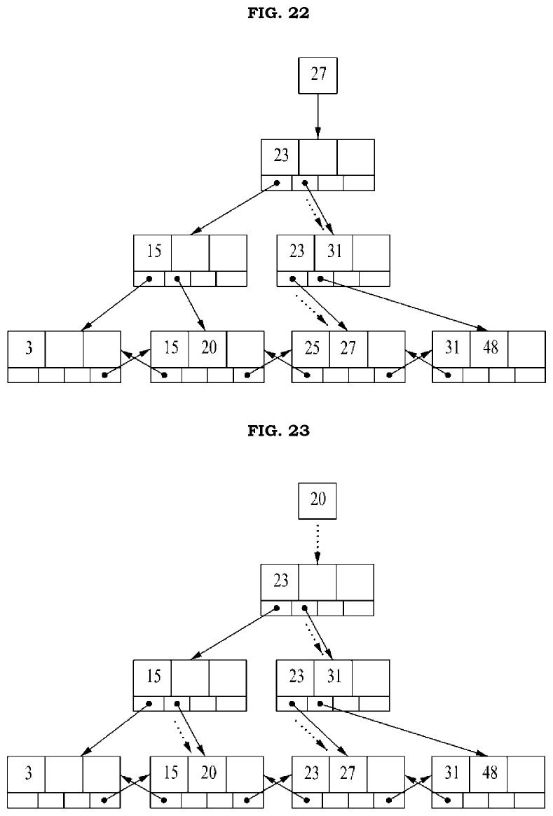

If insertion is performed, when the location where data will be inserted is found, binary search is used. As may be seen from FIG. 22, in a linked B+ tree, each node has a structure optimized for binary search, and the elements of the node have already been arranged. Accordingly, to find the location where data will be inserted using binary search is most efficient.

FIG. 23 is a diagram showing a process of searching a linked B+ tree for data 20.

As in the insertion, in search for data, binary search is used. A difference is that binary search is used twice in search for data. In the insertion, if a node at a location for insertion is found, insertion can be immediately performed because there is position information that needs to be stored within the corresponding node. However, in search, after a node to which corresponding data will belong is found using binary search, binary search is performed once more in order to search the corresponding node for actual data. Although binary search is performed twice, less than 1 second is taken to search a memory for tens of millions of data because all nodes and the elements of each node have been arranged in the linked B+ tree characteristic.

Prior to the description of the HDFS, first, the Hadoop HDFS and Map/Reduce need to be described more specifically. An indexing scheme for common file-based searching has an idea for searching for only a necessary portion without searching all files upon searching because the offset of a file has been previously designated. Accordingly, data is present in a file or memory containing index information. However, the indexing scheme having an object of increasing a search speed using Map/Reduce in the HDFS needs to be approached using a slightly different method.

In a Map/Reduce task for search, only map tasks are chiefly used. In this case, a resource manager previously calculates how many map tasks will be necessary based on the size of an input data set. This number is changed depending on the size of the data set that is processed in the map tasks. A file in the HDFS is practically divided into several InputSplits. The InputSplits are directly associated with a mapper instance.

Accordingly, the number of mappers has direct association with the number of InputSplits. Eventually, if the number of mappers necessary for search is reduced, overall speed improvement can be achieved. InputSplit has the following three different values.

1) The File Name, 2) The offset (the start point of InputSplit), 3) The Length (the end point of InputSplit).

When toString( ) that is, a method of InputSplit, is invoked, the data of the following pattern is returned.

dfs://server.domain:8020/path/to/my/file:0+100000

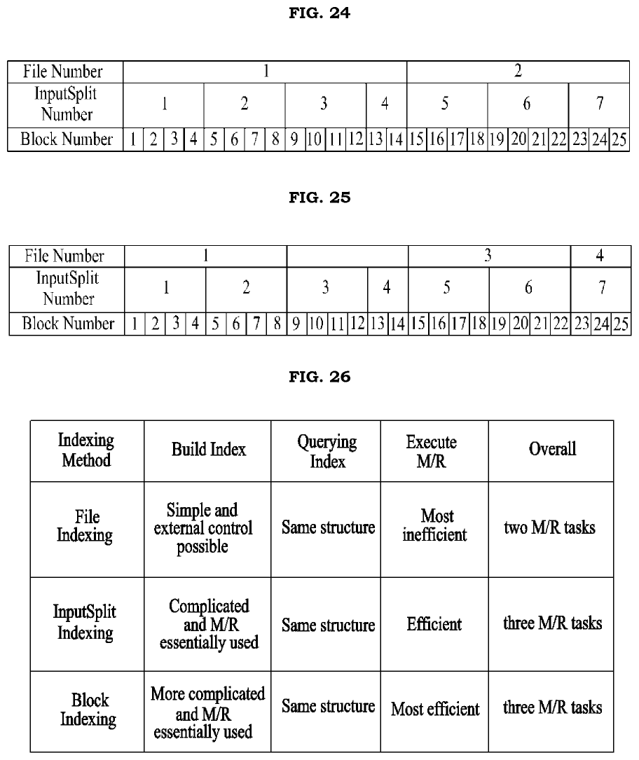

Indexing in the HDFS may be implemented in three step (File level, InputSplit Level, Block Level). FIG. 24 is a diagram showing a data structure in the HDFS.

In the illustrated example, two different files are configured with 25 blocks. The 25 blocks are divided into seven different InputSplits. Data to be searched for by a user is located in a shadow portion. The above exemplary may have the following effects in the above proposed three different indexing schemes.

File base indexing has the same effects as Full Scanning. InputSplit Base Indexing can expect performance improvement of about 75% by reading only 4 of the 7 InputSplits. Block base indexing can expect performance improvement of about 6 times by reading only 7 of the 25 blocks.

FIG. 25 is a similar case, and is a case assuming that desired data has gathered at the front of a No. 1 file. The above example may expect the following effects.

The file base indexing can expect performance improvement of about 4 times by reading only one file of four files. InputSplit Base Indexing can expect performance improvement of about 7 times by reading only one of 7. The block base indexing can expect performance improvement of about 7 times by reading only four of the 25 blocks.

This calculation method overlooks one great fact. This is the time when an indexing file is generated. Particularly, in the TeraStream BASS, there is a condition in which an index needs to be rebuilt every search because data search must be performed in real time.

A method of applying an index to Map/Reduce includes a total of three steps. Building Index, Querying Index, and Execute Map/Reduce are performed. A detailed implementation scheme is handled in a subsequent technology and algorithm section. In this context, the proposed three indexing methods are compared and described.

First, a detailed description of each step is as follows.

\textcircled{1} The Build Index step is a process of connecting index data and a file name or an input split or block. A result value output in this step is as follows. For example, an expression that data called 123, 234, 456, and 567 are positioned as a specific location of a file below a specific path is as follows.

123 dfs://domain:8020/path/to/my/file:0+6

234 dfs://domain:8020/path/to/my/file:7+13

456 dfs://domain:8020/ path/to/my/file:14+20

567 dfs://domain:8020/path/to/my/file:21+27

\textcircled{3} The Querying Index step is a method of extracting a value suitable for a query input by a user among the output values of the Build Index step. In the above example, if only 123 and 456 are extracted, the following results will be obtained.

123 dfs://domain:8020/path/to/my/file:0+6

456 dfs://domain:8020/path/to/my/file:14+20

\textcircled{3} In the Execute Map/Reduce step, a task is performed using only data, corresponding to an index in a received data set, as a new data set based on the results. In this process, performance improvement can be expected because the number of mappers executed is reduced because the task is performed using only some data instead of all data.

In the steps, advantages and disadvantages of each indexing method are as follows.

The file base indexing has a simple Building Index step. In a process of building an index based on a file name, the index may be generated before the index is inserted into Hadoop. Accordingly, the file base indexing may be said to be most appropriate in generating an index in real time.

In InputSplit Base Indexing, an index may be built after data is inserted into the HDFS in the Build Index step. The reason for this is that when a file is added from the outside, an upper layer of Hadoop cannot be aware of how Input Split is internally performed. Accordingly, there is a disadvantage in that Map/Reduce must be performed once from the Build Index step. This method is more efficient than file indexing after the Build Index step.

The general block base indexing method operates similar to InputSplit Base Indexing, but the Build Index step becomes more complicated. Accordingly, it is difficult to expect overall performance improvement other than an exceptional case.

In the TeraStream BASS, the file indexing of the three indexing methods is used. The reason for this is that an index is built in a process of downloading data on a memory to the HDFS. Accordingly, the file indexing scheme is used on the basis that overall performance improvement is most efficient due to an advantage in that the first step can be skipped.

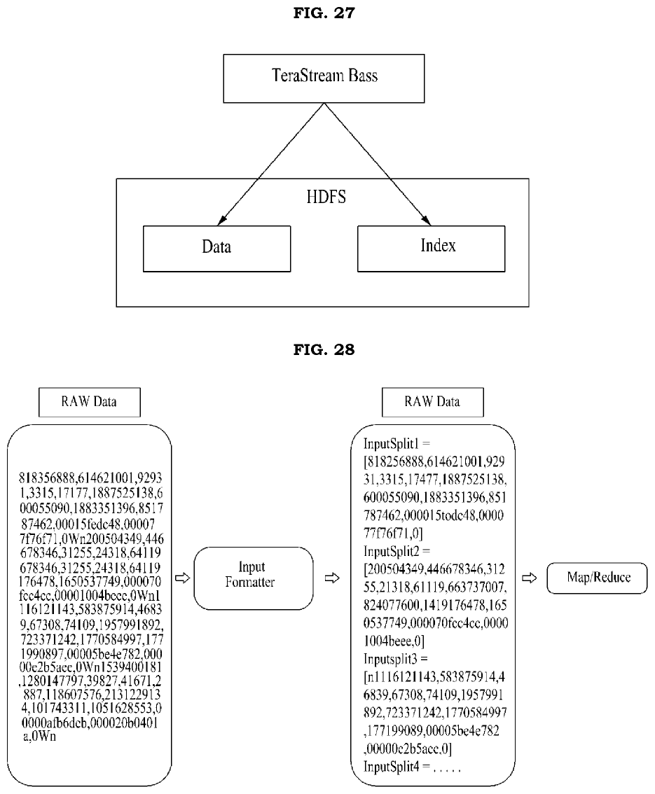

FIG. 27 describes a situation when data on a memory is moved from the TeraStream BASS to the HDFS. When data is downloaded, the TeraStream BASS generates an index file corresponding to a key value of the data together because the TeraStream BASS can be aware of a file name into which a corresponding file will be inserted. Through such a process, there may be an advantage for a build indexing process due to an advantage in that an index can be built at the same time when data is generated.

Data generated from the TeraStream BASS has the following form.

123 dfs://domain:8020/path/to/my/file:1

234 dfs://domain:8020/path/to/my/file:2

456 dfs://domain:8020/path/to/my/file:3

567 dfs://domain:8020/path/to/my/file:4

A Map/Reduce task for refining only index information to which input data matched with a query input by a user belongs is performed using the data as an input.

If the user wants a file having a key value smaller than 500 and greater than 100, the following output is output based on the information.

234 dfs://domain:8020/path/to/my/file:2

456 dfs://domain:8020/path/to/my/file:3

The output value is used in Execute Map/Reduce, that is, a next step.

The Execute Map/Reduce step operates similar to the existing convert engine of TeraStream for Hadoop. However, in order to describe a difference from the convert engine based on full search, the convert engine and the indexed HDFS searching method need to be compared.

FIG. 28 is a method used when full searching is used in the TeraStream BASS as the convert engine of TeraStream for Hadoop. This is a method of filtering out a sentence inquired by a user on the Map/Reduce side. This method is the most basic method for producing the contents of all files as an input split and transmitting it to the mapper.

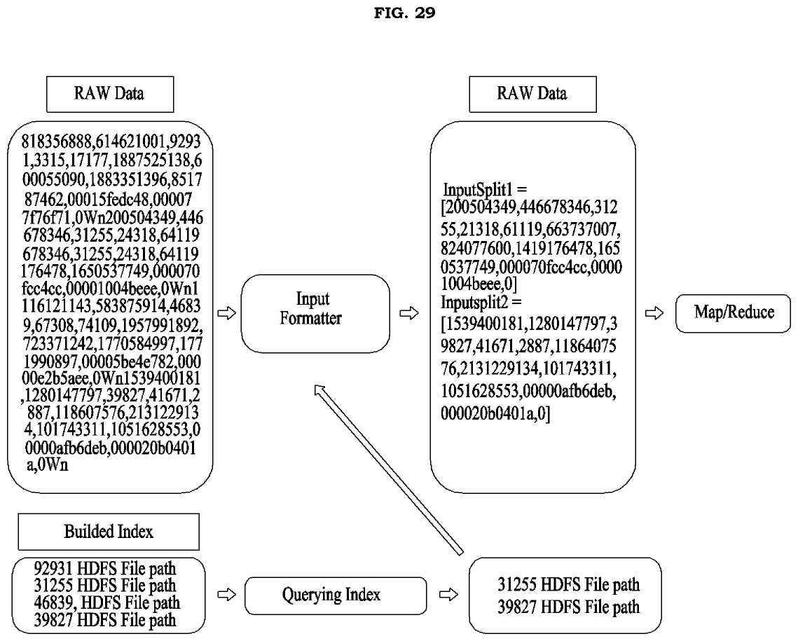

In contrast, the method of FIG. 29 is a method operating with respect to a query sentence, in which a user finds a column value between 30000˜39999 among values of the third column. A corresponding precondition starts on the assumption that a corresponding column is indexed. When a scheme is actually defined in the TeraStream BASS, an index column is pre-defined. An index value matched with a query sentence condition requested by a user is searched for in the defined indexed column using Map/Reduce. After results generated as described above are transmitted to an input formatter, the input formatter produces input splits necessary for Map/Reduce by merging raw data and the querying index results. Results generated as described above show performance much faster than full searching.

In the state in which HDFS storage has been excluded, tests were performed in order to check a maximum in-memory storage speed which may be achieved in one slave node and maximum in-memory storage speed which may be achieved when the number of nodes is increased in the entire framework.

All of a transmission emulator, a master node, and a slave node start up in one server. The reason why tests are performed as described above is for using a local network in order to corresponding restriction because a network between in-house servers is configured as a 1 Gbits/s network.

The emulator infinitely repeatedly transmits one million cases of data having the following characteristics.

With respect to packet-flow data, a total of 12 columns, 6 key columns (no key redundancy), and a data size of 118 bytes for each case, 2˜10 slave nodes start up. Each slave generates 100 10-MB memory blocks.

While the test scenario is performed, a local network speed according to the number of nodes was monitored for 1 minute using a nmon utility.

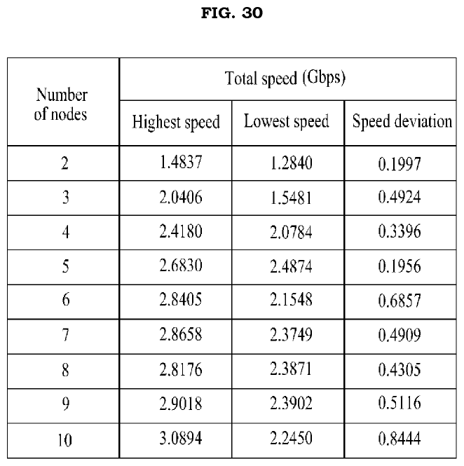

As shown in FIG. 30, as the results of the monitoring, a maximum speed recorded in one slave node is about 0.74 Gbits/s when the number of nodes is two, and about 840,000 cases of data was processed per second. When viewed based on all the slave nodes, the maximum speed is about 3.08 Gbits/s when the number of nodes is ten, and 3,510,000 cases of data was processed per second.

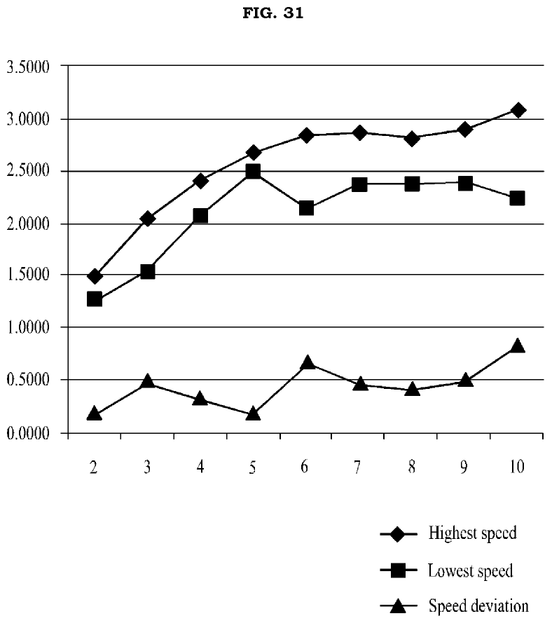

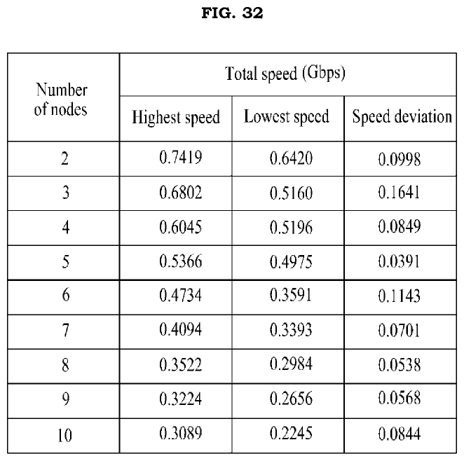

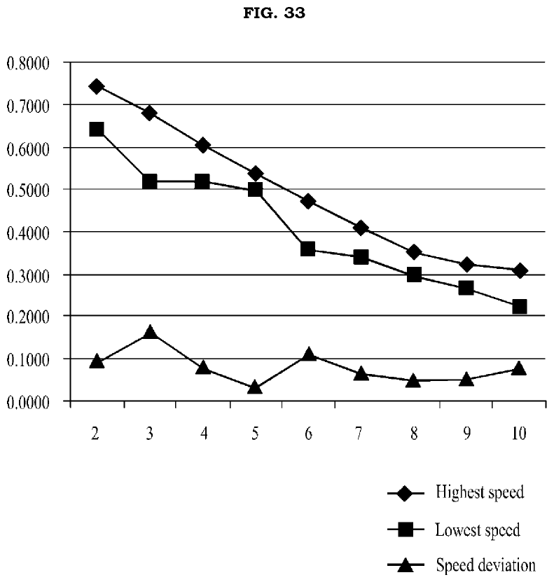

From FIGS. 30 to 33, it can be seen that the processing speed of one node is high as the number of nodes is reduced. The reason for this is that a limited system resource can be efficiently used even by a small number of nodes due to session multiplying. Such a phenomenon becomes more prominent because all the master, slave, and emulator started up in one host.

Furthermore, a speed rise according to the number of nodes is evidently shown. It can be seen that an upward trend is reduced as the number of nodes is increased. This is a phenomenon appearing because a system resource limited as described above must be divided and used by several processes. Practically, if a 10 Gbits/s network is configured and each slave node is executed in several host machines, it is expected that greater performance improvement can be achieved. From these test results only, in order to achieve the current speed of 10 Gbps, that is, a maximum network band, about 14 machines are necessary. However, when considering that the number and size of key columns of test data (packet-flow similar data) exceeds 50% of all data, better performance may be achieved depending on data characteristics.

In the state in which only an indexing module operates in one node, pure indexing performance is measured. In performance measurement target data, the size of one record is 128 bytes. Data in which the size of a corresponding key is 16 bytes is repeatedly inserted 10 times every ten million cases. The time taken whenever the data is accumulated every ten million case is measured. Furthermore, after the insertion, various search operations supported by the TeraStream BASS is performed on one hundred million cases of data, and performance is measured.

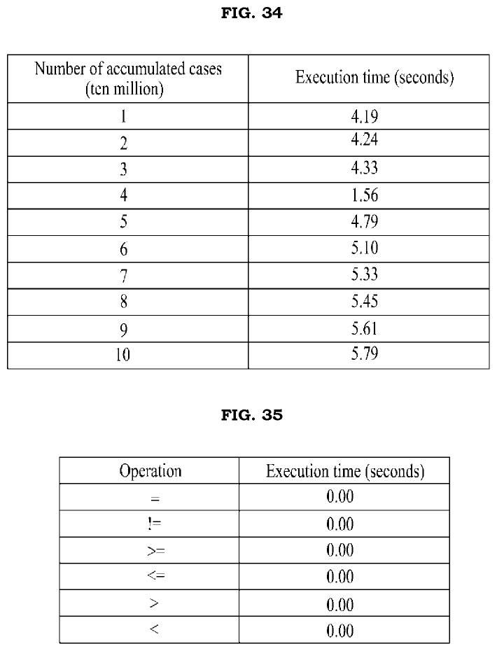

FIG. 34 shows the results of the measurement of the time taken to index one hundred million cases of data by repeatedly inserting the data 10 times every ten million cases. From FIG. 34, the time taken to insert data up to ten million cases is 4.19 seconds, and thereafter data is accumulated and inserted every ten million cases, but a time difference is not great. This is the results appearing because the re-distribution algorithm of the B tree-series index scheme always makes a tree uniform. Accordingly, it can be seen that a lot of data collected at an ultra-high speed can be stably stored and the amount of already stored data does not have a great influence on storage performance of data that is stored in real time.

FIG. 35 shows the results of the measurement of the time taken to execute each operation with respect to the one hundred million cases of data inserted in FIG. 34. As can be seen from the results, the memory search time of the linked B+ tree may be considered to be not present.

Accordingly, it can be seen that the index & search technology proposed in the present invention can stably store data collected at an ultra-high speed and also perform search in real time.

A Hadoop server operating in an office was used for the measurement of HDFS search performance as a test system.

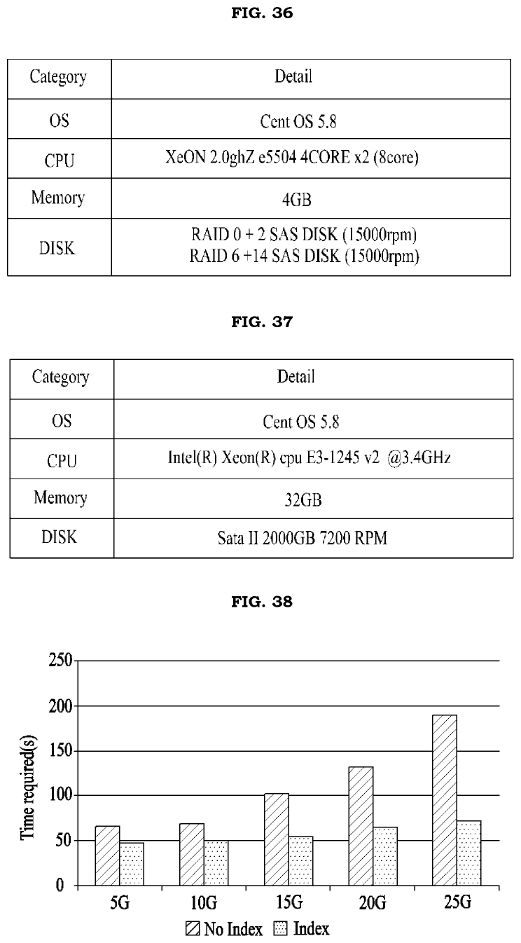

The specifications of NameNode equipment used for the tests are shown in FIG. 36. The specifications of Datallode equipment are shown in FIG. 37. 15 DataNodes are identically used, and Hadoop has been installed.

A Hadoop Version used is Hadoop 2.3.0-cdh5.0.0.

This is a condition in which a variable SAM file having data of a predetermined structure is read from the HDFS, data whose second column is matched with the condition is searched for in the data, and a corresponding row is output.

The data used is a variable, and is configured with a total of 11 columns.

The TeraStream BASS supports fixed data, but chiefly performs only a variable data indexing test because it makes it a rule to perform variable data processing.

The HDFS Indexing Searching is a method produced for the TeraStream BASS, and needs to omit the Build Index step. Accordingly, an index suitable for data is previously generated, and the tests were performed.

The performance comparisons were performed with respect to 5G, 10G, 15G, 20G, and 25G. Among them, records matched with the conditions are 2 cases, 4 cases, 6 cases, 8 cases, and 10 cases. A Hadoop Map/Reduce task for finding the cases was performed.

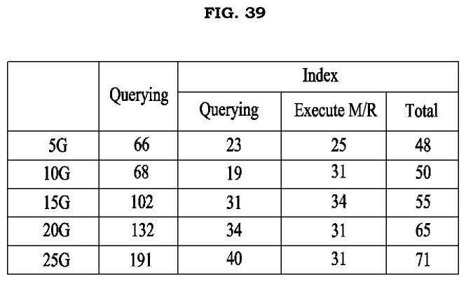

Test results are the same as FIGS. 38 and 39. The reason why test result times for 5G and 10G are similar is that the tests are ended almost at the same time because the number of available mappers of the test equipment is 144. However, it can be seen that the time is linearly increase from 15G. Furthermore, it can be seen that in overall performance, the speed is significantly fast compared to a task not a task using an index. This shows that a processing time is reduced in an environment in which an index has been previously built.

Although the invention performed the inventor of the present invention has been specifically described based on the embodiment, the present invention is not limited to the embodiment, and it is evident to a person having ordinary knowledge in the field that the present invention may be changed in various ways without departing from the gist of the present invention.

The present invention is applied to a technology for storing and searching for a large amount of data in real time.

What is claimed is:

1. A system for storing and searching for big data in real time, comprising:
a data collection unit collecting data through a TeraStream BASS data source API (BDI) which is a data source library;
a data storage control unit dualized as a memory cluster for real-time data collection and a Hadoop cluster which is a disk storage space; and
a data search and storage controller integrating and managing cluster configured in the data storage control unit, managing the data collection of the data collection unit, and managing results of the search so that the results are transmitted to a web or a user interface (UI) in response to a search request from a client,
wherein the data storage control unit performs data storage and search based on a storage section in which the BDI transmits data and a slave node stores data in a memory block and a query section in which the BCI transmits a query and receives retrieved data.

2. The system of claim 1, wherein the data search and storage controller previously allocates data to be used in each node of the memory cluster of the data storage control unit and directly stores, in the each node, data collected from the BDI.

3. The system of claim 1, wherein the data search and storage controller divides a total memory to be used into a plurality of small memory blocks and processes a unit in which data is stored in an HDFS storage in the divided small memory block unit.

4. The system of claim 1, wherein the data search and storage controller distributes and stores, in all nodes, data transmitted by one BDI and stores only data of one schema in one memory block.

5. The system of claim 1, wherein in the data search and storage controller, when data search is requested using a BASS SQL through the TeraStream BASS client API (BCI), a master performs syntax checking on the data, transmits an SQL to all slave nodes, and performs the corresponding data search in indices of all memory blocks in which the corresponding schema has been stored based on the SQL.

6. The system of claim 1, wherein in the data search and storage controller, when requested data search is accompanied by HDFS cluster search, a Map/Reduce program for data search is automatically generated, search is executed based on data of all the Hadoop clusters, and results of the execution are transmitted to the BCI.

7. The system of claim 1, wherein:
the data search and storage controller and the client perform a server-client connection using a connector-adapter connection model,
the connector is an object used by a client program when the client program accesses a server program, and comprises a protocol for a login request, command transmission and response reception, and logoff notification, and
the adapter is an object used by the server program when the server program receives access from the client program, and comprises a protocol for login approval, command processing and response transmission, and logoff processing.

8. The system of claim 1, wherein:
the data search and storage controller comprises a master node host machine and a slave node host machine, and
the master node host machine controls a slave node through an object called a slave map, and
wherein:
the slave map comprises a set of slave descriptor objects in a lower level, and
the slave descriptor directly communicates with the slave node based on reference to a slave adapter.

9. The system of claim 8, wherein the master node host machine manages a periodic exchange of heart bits, a start-up/end/removal of a specific slave node, and an addition of a new slave node.

10. The system of claim 1, wherein:
the data storage control unit manages memory blocks using an object called a memory map, and
the memory map manages memory blocks using a queue and stack having reference to a pre-allocated memory block as an element.

11. The system of claim 10, wherein the memory map checks a stack of memory blocks reference to all of the memory blocks has been stored in a free block stack, assigns a memory block, changes a state of the memory block to “BUSY”, increases a value called a holding count by 1, changes the state of the memory block to “FULL” when the memory block is full or a session in which data is transmitted is terminated, and registers reference to the corresponding memory block in a full block queue.

12. The system of claim 1, wherein the BDI of the data collection unit and the BCI of the client directly access all slave nodes, and store collected data or search for stored data.

13. The system of claim 1, wherein the data storage control unit stores data in an HDFS from old data in order to secure availability of a memory.

14. The system of claim 1, wherein:
the data search and storage controller uses a producer-consumer model for data storage and search,
the producer uses a structure in which data is buffered through an interface call, and
the consumer uses a structure in which data is periodically checked in a buffer and the data is transmitted in bulk when the data is present, and transmits a large amount of data at a high speed through a periodic transmission model using the structure, and
wherein the periodic transmission model implements load balancing using a Round-Robin method.

15. The system of claim 1, wherein the data search and storage controller improves data high-speed transmission performance by establishing several connections in one slave and increasing a degree of transmission parallelism.

16. The system of claim 1, wherein the data search and storage controller prevents a data loss by separately writing an end of data finally transmitted by a consumer in a consumer thread and reading data inserted by a producer from a written location when subsequently reading data from an identical buffer unit.

17. The system of claim 1, wherein the data search and storage controller searches for stored data using a linked B+ tree implemented by a leaf node as a double link for stored data search.

18. The system of claim 1, wherein when insertion and search of data occurs, the data search and storage controller searches for a location into which data is to be inserted and a search location using binary search, and performs the binary search twice when searching the data.

19. The system of claim 1, wherein the data storage control unit simultaneously generates an index file corresponding to a key value of data based on a file name into which a corresponding file is to be inserted when moving data in a memory to an HDFS.

20. The system of claim 1, wherein the data search and storage controller performs HDFS search in such a manner that an index value matched with a query sentence condition requested by a user with respect to a predefined indexed column is searched for using Map/Reduce and an input formatter collects raw data and querying index results based on generated results and generates input splits necessary for the Map/Reduce.
